(19) United States
(12) Patent Application Publication
(10) Pub. No.: US 2019/0127050 A1
(43) Pub. Date: May 2, 2019

(54) FLIGHT CONTROL SYSTEMS AND METHODS

(71) Applicant: Sikorsky Aircraft Corporation, Stratford, CT (US)

(72) Inventors: Robert S. Takacs, Oxford, CT (US); Anthony Smith, Trumbull, CT (US)

(21) Appl. No.: 15/799,407

(22) Filed: Oct. 31, 2017

(51) Int. Cl. B64C 13/50

(52) U.S. Cl. CPC B64C 13/503; B64C 27/04

(57) ABSTRACT

A high-integrity, redundant flight control system includes a plurality of flight control computers each having a back-up inertial sensor embedded therein. At least one back-up inertial sensor provides a respective back-up signal to at least one of the flight control computers. The system includes a plurality of primary inertial sensors discrete from the flight control computers. Each primary inertial sensor is operatively connected to at least one respective flight control computer. Each inertial sensor provides a respective primary signal to its respective flight control computer.

### STATEMENT REGARDING FEDERALLY SPONSORED RESEARCH OR DEVELOPMENT

This invention was made with government support under Contract No. HR0011-17-9-0004 awarded by the Defense Advanced Research Projects Agency. The government has certain rights in the invention.

### BACKGROUND OF THE INVENTION

### 1. Field of the Disclosure

The present disclosure relates to air-vehicle systems, and more particularly to air-vehicles utilizing a fly-by-wire system.

### 2. Description of Related Art

Fly-by-wire control systems require high integrity and redundant vehicle state information. Typically, flight requirements include a minimum amount of three sources for attitude, heading and acceleration measurements. In many cases, a fourth source is often desired to provide fail down voting capability. Both the primary sources and secondary sources are typically in the form of heavy and expensive embedded global positioning system and inertial navigation systems (EGIs), attitude and heading reference systems (AHRS), inertial reference unit (IRU), or other similar “gyro” sources. These sources can drive vehicle cost and weight, and can require complex harness systems that can be timely and costly to install.

Such conventional methods and systems have generally been considered satisfactory for their intended purpose. However, there is still a need in the art for improved flight control systems and methods. The present disclosure provides a solution for this need.

### SUMMARY

A high-integrity, redundant flight control system includes a plurality of flight control computers each having a back-up inertial sensor embedded therein. At least one back-up inertial sensor provides a respective back-up signal to at least one of the flight control computers. The system includes a plurality of primary inertial sensors discrete from the flight control computers. Each primary inertial sensor is operatively connected to at least one respective flight control computer. Each inertial sensor provides a respective primary signal to its respective flight control computer.

It is contemplated that the flight control computers can be operatively connected to one another to share and compare data from one of the respective primary signals, the respective back-up signal, or both. For example, the flight control computers can be operatively connected to one another through a cross-channel data link to share and compare data from one of the respective primary signals, the respective back-up signal, or both.

In accordance with some embodiments, at least one of the back-up inertial sensors is a micro-inertial sensor, such as a micro-electro-mechanical system (MEMS). The plurality of flight control computers can include three flight control computers. The plurality of primary inertial sensors can include three primary inertial sensors. The at least one back-up inertial sensor can be a plurality of back-up inertial sensors, e.g. three back-up inertial sensors, wherein each back-up inertial sensor in the plurality of back-up inertial sensors provides a respective back-up signal to at least one of the flight control computers.

In accordance with another aspect, a method to determine vehicle state includes providing a first primary inertial signal to a first flight control computer from a first primary inertial sensor. The method includes providing a second primary inertial signal to a second flight control computer from a second primary inertial sensor. The method includes providing a back-up signal from a back-up inertial sensor to at least one of a third flight control computer, the first flight control computer, or the second flight control computer. The method includes comparing the first and second primary inertial signals to the back-up inertial signal with at least one of the three flight control computers to resolve any discrepancies between the first and second primary inertial signals. The method includes using at least one of the first or second primary inertial signals to determine a vehicle state of an aircraft.

It is contemplated that the method can include determining whether a third primary inertial signal from a third primary inertial sensor is robust or insufficient, and comparing the first and second primary inertial signals to the back-up inertial signal with at least one of the flight control computers only if the third primary inertial signal is insufficient.

The method can include providing a third primary inertial signal from a third primary inertial sensor to the third flight control computer, and comparing the first, second and third primary inertial signals to one another to resolve any discrepancies between the first, second and third primary inertial signals. Comparing the first and second primary inertial signals to the back-up inertial signal can include comparing the third primary inertial signal to the back-up inertial signal with at least one of the three flight control computers for added redundancy. Using at least one of the first or second primary inertial signals to determine a vehicle state of an aircraft can include using at least one of the first, second or third primary inertial signals to determine a vehicle state of an aircraft.

The back-up signal can be a designated back-up signal from a plurality of back-up signals. Each back-up signal of the plurality of back-up signals can be from a respective back-up inertial sensor. Each back-up inertial sensor can be operatively connected to at least one of the three flight control computers. The method can include comparing the plurality of back-up signals to one another to determine which is the designated back-up signal. The method can include comparing the first and second primary inertial signals to one or more of the plurality of back-up signals with at least one of the three flight control computers for added redundancy. The method can include comparing the third primary inertial signal and the first and second primary inertial signals to one or more of the plurality of back-up signals with at least one of the three flight control computers for added redundancy.

The method can include communicating the first and second primary inertial signals and the back-up inertial signal between at least two of the first, second or third flight control computers. In accordance with some embodiments, the method includes communicating the first and second primary inertial signals and the back-up inertial signal between at least two of the first, second or third flight control computers with a cross-channel data link.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic view of an exemplary embodiment of an aircraft having an embodiment of a flight control system constructed in accordance with the present disclosure;

FIG. 2 is a schematic view of the flight control system of FIG. 1, showing the flight control computers each having a back-up inertial sensor embedded therein; and

FIG. 3 is a schematic block diagram showing an exemplary embodiment of a method to determine vehicle state.

### DETAILED DESCRIPTION OF THE PREFERRED EMBODIMENTS

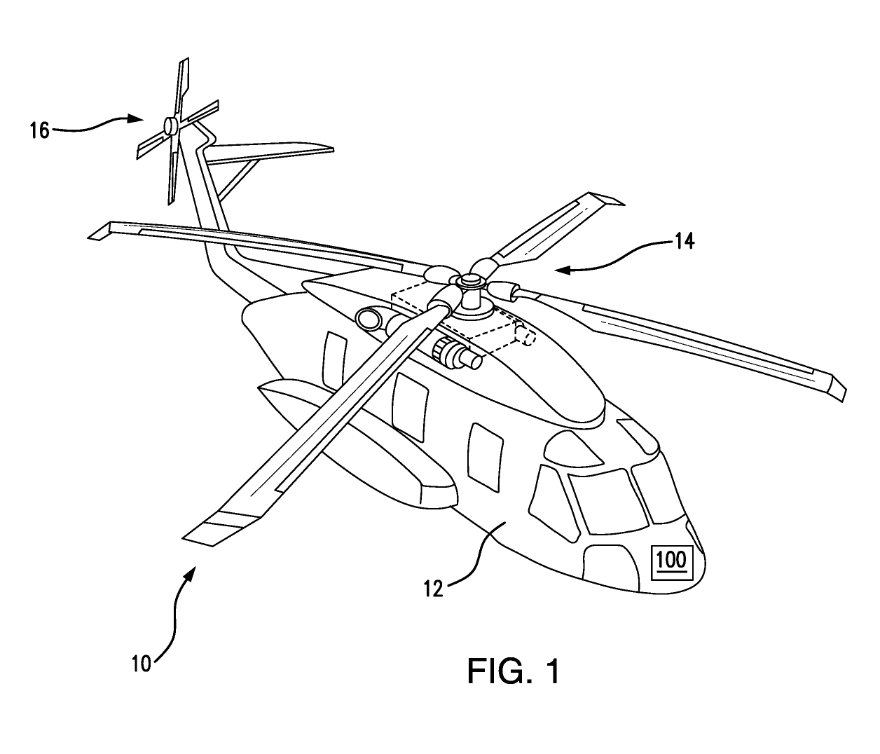

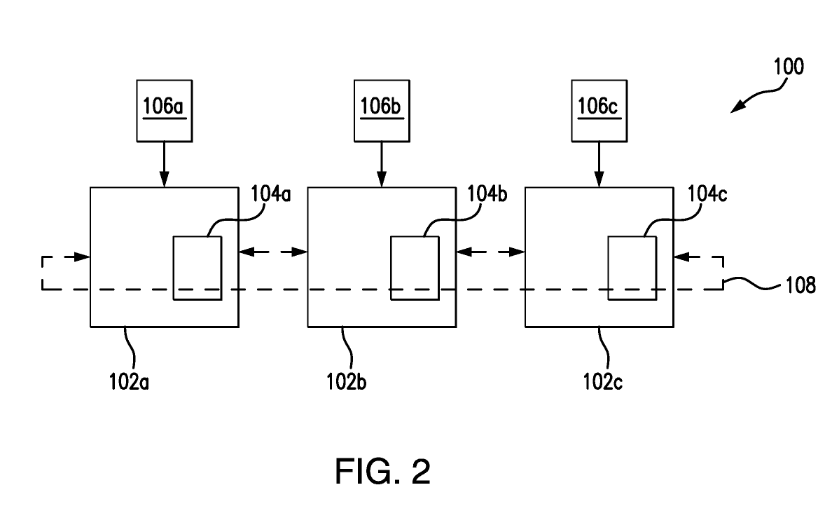

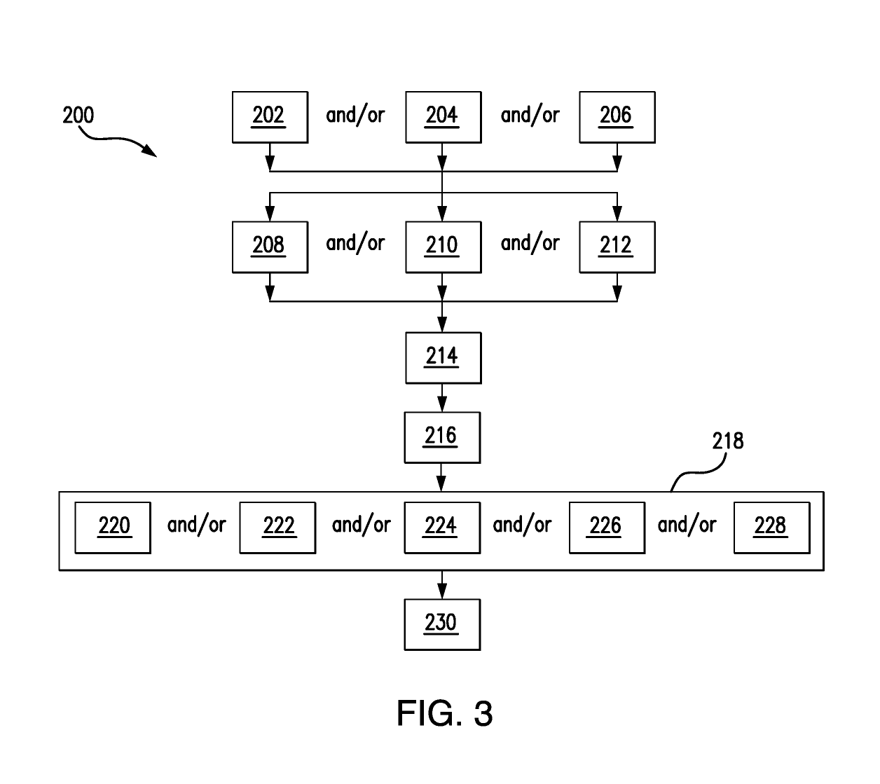

Reference will now be made to the drawings wherein like reference numerals identify similar structural features or aspects of the subject disclosure. For purposes of explanation and illustration, and not limitation, an exemplary embodiment of a flight control system constructed in accordance with an embodiment of the disclosure is shown in FIGS. 1 and 2, and is designated generally by reference character 100. Other embodiments of bearings in accordance with the disclosure, or aspects thereof, are provided in FIG. 3, as will be described. The systems and methods described herein can be used to reduce weight, cost and complexity of flight control systems that require redundancy and high-integrity.

As shown in FIG. 1, aircraft 10 is a helicopter and includes an airframe 12, main rotor 14, and tail rotor 16. Main rotor 14 is driven about its main rotor shaft, which is in turn driven by a powertrain system. Control commands for components of aircraft 10, such as the main rotor 14 and the tail rotor 16, and/or other components such as a main rotor shaft, aircraft powertrain system, and the like, are provided by using a flight control system 100. In order to provide commands using flight control system 100, high integrity and redundant vehicle state information is needed. This includes, for example, attitude, heading and acceleration measurements for aircraft 10. Flight control system 100 is shown positioned within the cockpit portion of the aircraft 10. However, it is contemplated that portions of or all of flight control system 100 can be in other locations throughout the aircraft 10, and/or off of the aircraft 10. Those skilled in the art will readily appreciate that the position shown for flight control system 100 in FIG. 1 is exemplary only, and that flight control system 100 can be used throughout aircraft 10, without departing from the scope of this disclosure.

With reference now to FIG. 2, flight control system 100 is a high-integrity, redundant flight control system 100. System 100 includes a plurality of flight control computers 102a-102c each having a respective back-up inertial sensor 104a-104c embedded therein. The system 100 includes a plurality of primary inertial sensors 106a-106c discrete from, but operatively connected to, the flight control computers 102a-102c. Primary inertial sensors 106a-106c can be connected to their respective flight control computers 102a-102c through wire harness, or the like. Primary inertial sensor 106a-106c are connected to the other flight control computers 102a-102 via a cross-channel data link 108. Each inertial sensor 106a-106c provides a primary signal to its respective flight control computer 102a-102c.

With continuing reference to FIG. 2, at least one of the back-up inertial sensors 104a-104c is a micro-inertial sensor, for example, a micro-electro-mechanical system (MEMS). Each back-up inertial sensor 104a-104c operates to provide a respective back-up signal to at least one of the flight control computers 102a-102c. In the event that one of primary inertial sensors 106a-106c is down, or not providing a usable primary inertial signal, at least one back-up inertial signal from one or more back-up inertial sensors 104a-104c is used to resolve discrepancies between the primary inertial signals that are usable. Additionally, even if all primary inertial sensors 106a-106c are running well and providing usable primary inertial signals, at least one back-up inertial signal from one or more back-up inertial sensors 104a-104c can be used as additional redundant comparators sources for added redundancy. Back-up inertial sensors 104a-104c embedded within their respective flight control computers 102a-102c provide a weight and cost reduction as compared to traditional systems that use heavy and expensive EGIs, AHRSs, IRUs or other gyroscopic sources as back-up inertial sensors separate from (e.g. non-embedded) traditional flight control computers. Each traditional gyroscopic back-up source requires more wiring and takes up more space, as compared with embedded back-up inertial sensors 104a-104c. Moreover, traditional gyroscopic back-up sources (e.g. EGIs, AHRSs and IRUs) weigh upwards of five pounds and can cost thousands of dollars, while a micro-inertial sensor can weigh ounces and cost pennies or dollars. As such, the weight savings can be on the scale of eight to twenty pounds, and the costs savings can be tens of thousands of dollars.

As shown in FIG. 2, the flight control computers 102a-102c are operatively connected to one another to share and compare data from one of the primary signals, one of the back-up signals, or both. In accordance with the embodiment depicted in FIG. 2, the flight control computers 102a-102c are operatively connected to one another through the cross-channel data link 108 to share and compare data from one of the primary signals, the back-up signal, or both. This comparing allows for one or more flight control computers to “vote” on and verify one more of the primary sources (and in some cases the back-up sources) to determine which is appropriate to use for determining a vehicle state of an aircraft, as described below.

As shown in FIG. 3, a method 200 to determine vehicle state includes providing a first primary inertial signal to a first flight control computer, e.g. flight control computer 102a, from a first primary inertial sensor, e.g. primary inertial sensor 106a, as indicated schematically by box 202. The method 200 includes providing a second primary inertial signal to a second flight control computer, e.g. flight control computer 102b, from a second primary inertial sensor, e.g. second primary inertial sensor 106b, as indicated schematically by box 204. It is contemplated that in some embodiments the method 200 includes providing a third primary inertial signal from a third primary inertial sensor, e.g. third primary inertial sensor 106c, to the third flight control computer, as indicated schematically by box 206.

The method 200 includes providing a back-up signal from a back-up inertial sensor, e.g. back-up inertial sensor 104c, to a third flight control computer, e.g. flight control computer 102c, the first flight control computer, and/or the second flight control computer, as indicated schematically by box 208. Moreover, in accordance with some embodiments, the method 200 includes providing a second back-up signal to one of the flight control computers from a second back-up inertial sensor, e.g. second back-up inertial sensor 104a, as indicated schematically by box 210. In accordance with some embodiments, the method 200 includes comprising providing a third back-up signal to the second flight control computer from a third back-up inertial sensor, e.g. third back-up inertial sensor 104b, as indicated schematically by box 212.

The method 200 includes determining whether a third primary inertial signal from the third primary inertial sensor is robust or insufficient, as indicated schematically by box 214. In the event the third primary inertial sensor is not robust or sufficient, the method 200 includes communicating one or more primary inertial signals and one or more back-up inertial signals between flight control computers. The method 200 includes communicating first and second primary inertial signals and the back-up inertial signal between at least two of the first, second or third flight control computers, e.g. communicating with a cross-channel data link 108, as shown schematically by box 216. Embodiments that include providing multiple back-up signals can be used for additional redundancy in situations where one or more of primary inertial signals are still useful, or can be used to further cross-check for discrepancies against the first back-up signal where only one or no primary inertial signals are available.

The method 200 includes comparing primary inertial signals to one another, comparing one or more back-up signals to one or more primary inertial signals, and/or comparing the back-up signals to one another, as indicated schematically by box 218. This comparing includes comparing the plurality of back-up signals to one another to determine which is the designated back-up signal to then be compared with one or more of the primary inertial signals, as indicated schematically by box 220. This comparing includes comparing the first and second primary inertial signals to the designated back-up inertial signal with at least one of the three flight control computers if the third primary inertial signal is insufficient to resolve any discrepancies between the first and second primary inertial signals, as indicated schematically by box 222. During the comparison process, one or more of the primary sources (and in some cases the back-up sources) are “voted” on and verified by the comparisons to determine which is appropriate to use for determining a vehicle state of an aircraft, as described below. In some embodiments, a “voted” on solution verified through comparison of one or more of primary inertial signals can then be compared with a “voted” on back-up inertial signal solution designated through a comparison across all of the back-up inertial signals. In other words, the vote across the back-up inertial signals selects which back-up inertial signal is the designated back-up inertial signal. Then, the designated back-up inertial signal can be used to verify, e.g. “tie-break”, a comparison operation between one or more of the primary inertial signals.

In some embodiments, comparing the first and second primary inertial signals to the back-up inertial signal includes comparing the third primary inertial signal (if usable) to the back-up inertial signal with at least one of the three flight control computers for added redundancy, as indicated schematically by box 224. In accordance with some embodiments, the method 200 includes comparing the first second primary inertial signal, the second primary inertial signal and/or the third primary inertial signal to one or more of the plurality of back-up signals with at least one of the three flight control computers for added redundancy in resolving discrepancies between the primary inertial signals, as indicated by box 226. It is contemplated that the method 200 can include comparing the first, second and third primary inertial signals to one another to resolve any discrepancies between the first, second and third primary inertial signals, as indicated schematically by box 228. Those skilled in the art will readily appreciate that a variety of comparison combinations can be used in order to obtain increased redundancy and integrity.

The method 200 includes using at least one of the first and second primary inertial signals to determine a vehicle state of an aircraft, e.g. an aircraft 10, as indicated schematically by box 230. In cases where no primary inertial signals are available, it is contemplated that one of the three back-up signals can be used to determine a basic aircraft state, e.g. rough estimates of altitude and aircraft orientation with respect to gravity.

The methods and systems of the present disclosure, as described above and shown in the drawings, provide for flight control systems with superior properties including reduced weight, cost and complexity. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A high-integrity, redundant flight control system comprising:
a plurality of flight control computers each having a back-up inertial sensor embedded therein, wherein at least one back-up inertial sensor provides a respective back-up signal to at least one of the flight control computers; and
a plurality of primary inertial sensors discrete from the flight control computers, wherein each primary inertial sensor is operatively connected to at least one respective flight control computer, wherein each inertial sensor provides a respective primary signal to its respective flight control computer.

2. The flight control system as recited in claim 1, wherein the flight control computers are operatively connected to one another to share and compare data from one of the respective primary signals, the respective back-up signal, or both.

3. The flight control system as recited in claim 1, wherein the flight control computers are operatively connected to one another through a cross-channel data link to share and compare data from one of the respective primary signals, the respective back-up signal, or both.

4. The flight control system as recited in claim 1, wherein at least one of the back-up inertial sensors is a micro-inertial sensor.

5. The flight control system as recited in claim 1, wherein at least one of the back-up inertial sensors is a micro-electro-mechanical system (MEMS).

6. The flight control system as recited in claim 1, wherein the plurality of flight control computers includes three flight control computers.

7. The flight control system as recited in claim 1, wherein the plurality of primary inertial sensors includes three primary inertial sensors.

8. The flight control system as recited in claim 1, wherein the at least one back-up inertial sensor is a plurality of back-up inertial sensors, wherein each back-up inertial sensor in the plurality of back-up inertial sensors provides a respective back-up signal to at least one of the flight control computers.

9. A method to determine vehicle state, the method comprising:
providing a first primary inertial signal to a first flight control computer from a first primary inertial sensor;
providing a second primary inertial signal to a second flight control computer from a second primary inertial sensor;
providing a back-up signal from a back-up inertial sensor to at least one of a third flight control computer, the first flight control computer, or the second flight control computer;
comparing the first and second primary inertial signals to the back-up inertial signal with at least one of the three flight control computers to resolve any discrepancies between the first and second primary inertial signals; and
using at least one of the first or second primary inertial signals to determine a vehicle state of an aircraft.

10. The method as recited in claim 9, further comprising determining whether a third primary inertial signal from a third primary inertial sensor is robust or insufficient, and comparing the first and second primary inertial signals to the back-up inertial signal with at least one of the flight control computers only if the third primary inertial signal is insufficient.

11. The method as recited in claim 9, providing a third primary inertial signal from a third primary inertial sensor to the third flight control computer, and comparing the first, second and third primary inertial signals to one another to resolve any discrepancies between the first, second and third primary inertial signals.

12. The method as recited in claim 11, wherein comparing the first and second primary inertial signals to the back-up inertial signal includes comparing the third primary inertial signal to the back-up inertial signal with at least one of the three flight control computers for added redundancy.

13. The method as recited in claim 12, wherein using at least one of the first or second primary inertial signals to determine a vehicle state of an aircraft includes using at least one of the first, second or third primary inertial signals to determine a vehicle state of an aircraft.

14. The method as recited in claim 9, wherein the back-up signal is a designated back-up signal from a plurality of back-up signals, wherein each back-up signal of the plurality of back-up signals is from a respective back-up inertial sensor, wherein each back-up inertial sensor is operatively connected to at least one of the three flight control computers.

15. The method as recited in claim 14, further comprising comparing the plurality of back-up signals to one another to determine which is the designated back-up signal.

16. The method as recited in claim 14, further comprising comparing the first and second primary inertial signals to one or more of the plurality of back-up signals with at least one of the three flight control computers for added redundancy.

17. The method as recited in claim 14, further comprising comparing a third primary inertial signal from a third primary inertial sensor, and the first and second primary inertial signals to one or more of the plurality of back-up signals with at least one of the three flight control computers for added redundancy.

18. The method as recited in claim 9, further comprising communicating the first and second primary inertial signals and the back-up inertial signal between at least two of the first, second or third flight control computers.

19. The method as recited in claim 9, further comprising communicating the first and second primary inertial signals and the back-up inertial signal between at least two of the first, second or third flight control computers with a cross-channel data link.
